(19) United States
(12) Patent Application Publication
(10) Pub. No.: US 2017/0061432 A1
(43) Pub. Date: Mar. 2, 2017

(54) MULTI-USER TRANSACTION APPROVAL AUTHENTICATION

(71) Applicant: International Business Machines Corporation, Armonk, NY (US)

(72) Inventors: Vijay Ekambaram, CHENNAI (IN); Saravanan Sadacharam, CHENNAI (IN)

(21) Appl. No.: 14/836,395

(22) Filed: Aug. 26, 2015

(51) Int. Cl. G06Q 20/40

(52) U.S. Cl. CPC G06Q 20/405

(57) ABSTRACT

Approval authentication of transactions by multiple users. Transmitting and receiving approval for transactions based on rules and contact methods for an account.

### BACKGROUND

The present invention relates generally to the field of information security, and more particularly to access control or authentication.

Some accounts require multiple individuals to authorize and/or approve transactions. Additionally, some accounts require parents to authorize and/or approve transactions by children over a certain threshold. Some companies require employees receive authorization and/or approval from a manager to make purchases on a company account. Means of achieving authorization and/or approval include the use of personal identification numbers (PINs) or one-time passcodes (OTPs).

### SUMMARY

According to an aspect of the present invention, there is a method, computer program product, and/or system that performs the following operations (not necessarily in the following order): (i) determining a set of configured transaction rules for a transaction authorization request; (ii) transmitting an authorization inquiry to a set of legitimate users over a set of best contact methods, respectively; (iii) receiving from the set of legitimate users a set of responses to the authorization inquiry; and (iv) determining a result of the transaction authorization request based, at least in part, on the set of responses to the authorization inquiry. The set of legitimate users is based, at least in part, on the set of configured transaction rules. At least the determining a set of configured transaction rules operation is performed by computer software running on computer hardware.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram view of a machine logic (for example, software) portion of the first embodiment system; and

FIG. 4 is a flowchart showing a second embodiment method performed, at least in part, by a second embodiment of a system according to the present invention.

### DETAILED DESCRIPTION

Approval authentication of transactions by multiple users. Transmitting and receiving approval for transactions based on rules and contact methods for an account. This Detailed Description section is divided into the following sub-sections: (i) The Hardware and Software Environment; (ii) Example Embodiment; (iii) Further Comments and/or Embodiments; and (iv) Definitions.

### I. THE HARDWARE AND SOFTWARE ENVIRONMENT

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

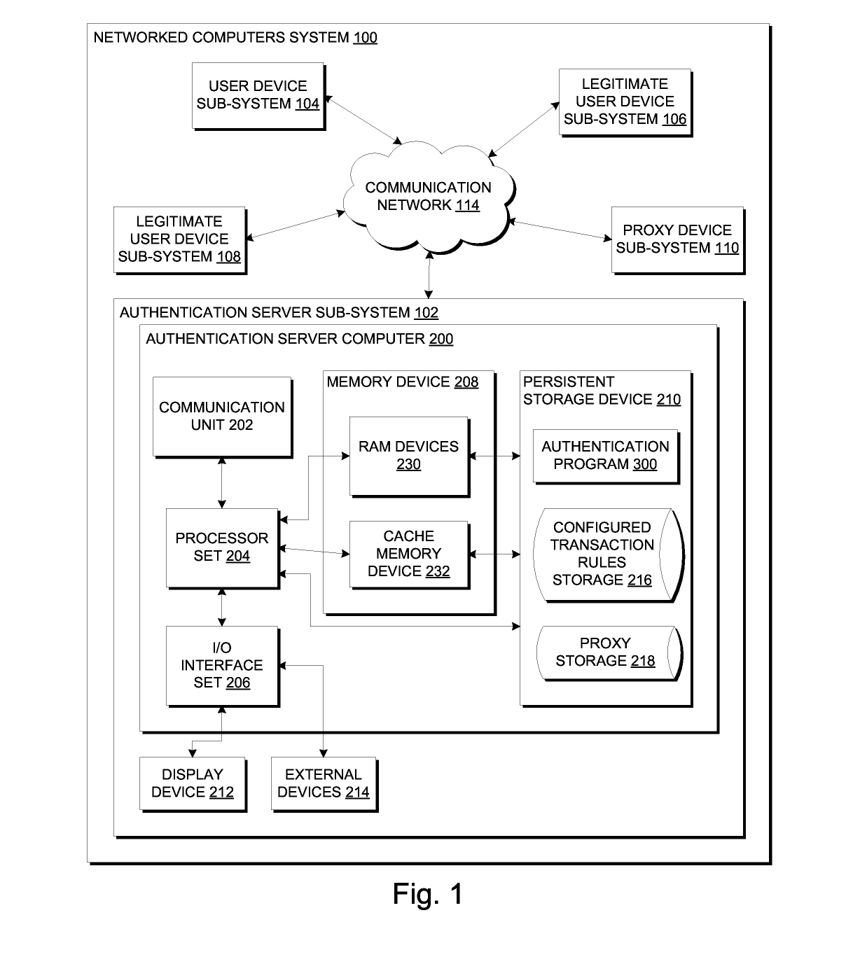

An embodiment of a possible hardware and software environment for software and/or methods according to the present invention will now be described in detail with reference to the Figures. FIG. 1 is a functional block diagram illustrating various portions of networked computers system 100, including: authentication server sub-system 102; user device sub-system 104; legitimate user device sub-systems 106, 108; proxy device sub-system 110; communication network 114; authentication server computer 200; communication unit 202; processor set 204; input/output (I/O) interface set 206; memory device 208; persistent storage device 210; display device 212; external devices 214; random access memory (RAM) devices 230; cache memory device 232; and authentication server program 300.

Authentication server sub-system 102 is, in many respects, representative of the various computer sub-system(s) in the present invention. Accordingly, several portions of authentication server sub-system 102 will now be discussed in the following paragraphs.

Authentication server sub-system 102 may be a laptop computer, tablet computer, netbook computer, personal computer (PC), a desktop computer, a personal digital assistant (PDA), a smart phone, or any programmable electronic device capable of communicating with the client sub-systems via communication network 114. Authentication server program 300 is a collection of machine readable instructions and/or data that is used to create, manage and control certain software functions that will be discussed in detail, below, in the Example Embodiment sub-section of this Detailed Description section.

Authentication server sub-system 102 is capable of communicating with other computer sub-systems via communication network 114. Communication network 114 can be, for example, a local area network (LAN), a wide area network (WAN) such as the Internet, or a combination of the two, and can include wired, wireless, or fiber optic connections. In general, communication network 114 can be any combination of connections and protocols that will support communications between server and client sub-systems.

Authentication server sub-system 102 is shown as a block diagram with many double arrows. These double arrows (no separate reference numerals) represent a communications fabric, which provides communications between various components of authentication server sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory device 208 and persistent storage device 210 are computer-readable storage media. In general, memory device 208 can include any suitable volatile or non-volatile computer-readable storage media. It is further noted that, now and/or in the near future: (i) external devices 214 may be able to supply, some or all, memory for authentication server sub-system 102; and/or (ii) devices external to authentication server sub-system 102 may be able to provide memory for authentication server sub-system 102.

Authentication server program 300 is stored in persistent storage device 210 for access and/or execution by one or more processors of processor set 204, usually through memory device 208. Persistent storage device 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage device 210.

Authentication server Program 300 may include both machine readable and performable instructions and/or substantive data (that is, the type of data stored in a database). In this particular embodiment, persistent storage device 210 includes a magnetic hard disk drive. To name some possible variations, persistent storage device 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage device 210 may also be removable. For example, a removable hard drive may be used for persistent storage device 210. Other examples include optical and magnetic disks, thumb drives, and smart cards that are inserted into a drive for transfer onto another computer-readable storage medium that is also part of persistent storage device 210.

Communication unit 202, in these examples, provides for communications with other data processing systems or devices external to authentication server sub-system 102. In these examples, communication unit 202 includes one or more network interface cards. Communication unit 202 may provide communications through the use of either or both physical and wireless communications links. Any software modules discussed herein may be downloaded to a persistent storage device (such as persistent storage device 210) through a communications unit (such as communication unit 202).

I/O interface set 206 allows for input and output of data with other devices that may be connected locally in data communication with authentication server computer 200. For example, I/O interface set 206 provides a connection to external devices 214. External devices 214 will typically include devices such as a keyboard, a keypad, a touch screen, and/or some other suitable input device. External devices 214 can also include portable computer-readable storage media such as, for example, thumb drives, portable optical or magnetic disks, and memory cards. Software and data used to practice embodiments of the present invention, for example, authentication server program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

### II. EXAMPLE EMBODIMENT

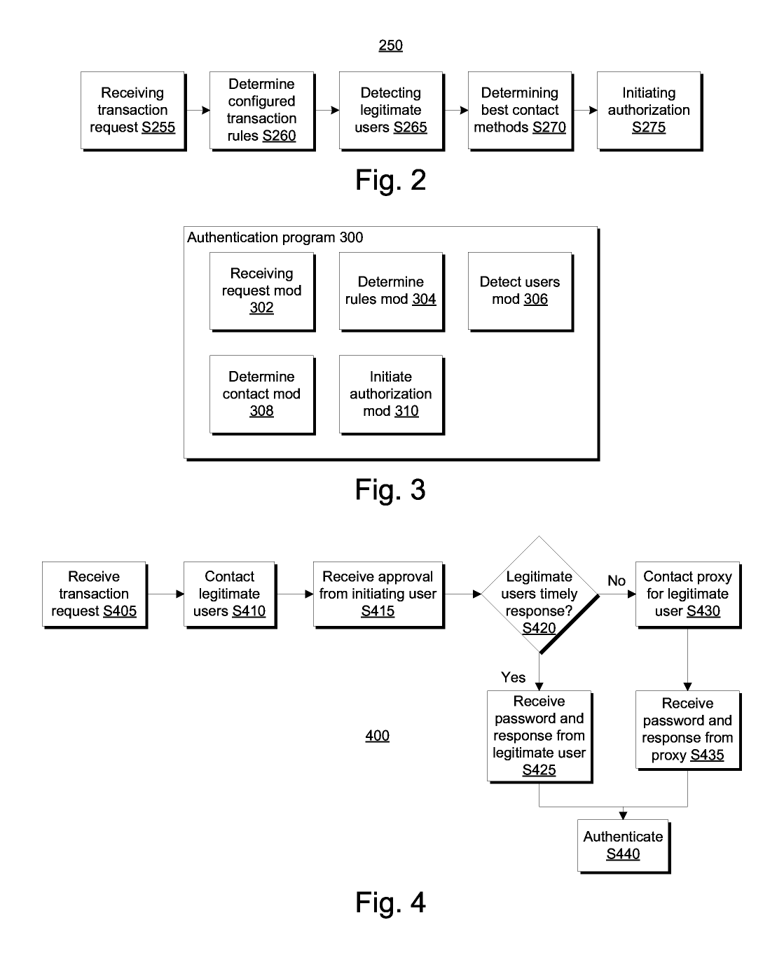

FIG. 2 shows flowchart 250 depicting a method according to the present invention. FIG. 3 shows authentication server program 300, which performs at least some of the method operations of flowchart 250. This method and associated software will now be discussed, over the course of the following paragraphs, with extensive reference to FIG. 2 (for the method operation blocks) and FIG. 3 (for the software blocks). In this example authentication server sub-system 102 (FIG. 1) receives a request to authorize a transaction from user device sub-system 104 (FIG. 1) for a ten thousand dollar ($10,000.00) purchase on a company account.

Processing begins at operation S255, where receiving request module (“mod”) 302 receives a request to authorize a transaction. In some embodiments of the present invention, the transaction is a purchase of goods and/or services for currency. Alternatively, the transaction is a barter. In some embodiments of the present invention, the request to authorize a transaction (also called a transaction authorization request) is initiated by a user in a set (i.e., at least one) of legitimate users. Alternatively, the transaction authorization request is initiated by a user not in a set of legitimate users. In some embodiments of the present invention, the transaction authorization request is initiated by a legitimate user and that legitimate user must also grant authorization for the transaction to be approved. In some embodiments of the present invention, the transaction authorization request is initiated by a legitimate user and that legitimate user is not required to grant authorization for the transaction to be approved. In some embodiments of the present invention, the request to authorize a transaction is initiated by a user whose authorization is not required for the transaction authorization request to be approved. In some embodiments of the present invention, a request to authorize a transaction is initiated from a user device subsystem. Alternatively, a request to authorize a transaction is initiated from a legitimate user device sub-system. In this example, request mod 302 receives from user device sub-system 104 a request to authorize a transaction for thousand dollars ($10,000.00) on a company account.

Processing proceeds to operation S260, where determine rules mod 304 determines a set of configured transaction rules. In some embodiments of the present invention, a set of configured transaction rules are stored within configured transaction rule storage 216. In some embodiments of the present invention, various configured transaction rules in the set of configured transaction rules implicate a variety of conditions related to the transaction authorization request. In some embodiments of the present invention, a set of configured transaction rules includes a set of monetary thresholds. In some embodiments of the present invention, a set of configured transaction rules includes a set of transaction categories (e.g., office supplies, travel, etc.). In some embodiments of the present invention, a set of configured transaction rules includes a set of legitimate users. In some embodiments of the present invention, a transaction authorization request implicates a plurality (i.e., more than one) of the set of configured transaction rules. In some embodiments of the present invention, a subset of the set of legitimate users must authorize a transaction. Alternatively, various legitimate users must authorize a transaction based, in part, on a subset of the configured transaction rules implicated by a transaction authorization request. In further alternative embodiments of the present invention, all legitimate users must authorize a transaction.

In some embodiments of the present invention, the set of configured transaction rules includes a set of tiebreaking rules that decide between multiple legitimate users that can authorize a transaction when less than all of those multiple legitimate users is required to authorize a transaction by the other configured transaction rules. For example, a configured transaction rule requires that one parent authorize a transaction by a child, but does not state which of the two parents must authorize the transaction. The tiebreaking rule determines that the father must authorize the transaction. In some embodiments of the present invention, the tiebreaking rule is a pseudo-random selection process.

In some embodiments of the present invention, a configured transaction rule requires additional legitimate users to authorize the transaction if the transaction authorization request is initiated on a user device subsystem. Alternatively, a configured transaction rule requires additional legitimate users to authorize the transaction if the transaction authorization request is initiated on a legitimate user device sub-system and the legitimate user that initiated the transaction authorization request is a legitimate user in the subset of legitimate users required to authorize the transaction. In further alternative embodiments of the present invention, a configured transaction rule requires fewer legitimate users to authorize the transaction if the transaction authorization request is initiated on a legitimate user device sub-system and the legitimate user that initiated the transaction authorization request is a legitimate user in the subset of legitimate users required to authorize the transaction. In some embodiments of the present invention, a configured transaction rule requires that a transaction authorization request cannot be initiated by a user device sub-system and must be initiated by a legitimate user device sub-system. In this example, the set of configured transaction rules include a configured transaction rule that transaction authorization requests initiated on a user device sub-system for amounts greater than five thousand dollars ($5,000.00) must be authorized by two legitimate users that are not the user initiating the transaction authorization request.

Processing proceeds to operation S265, where detect users mod 306 detects a subset of the set of legitimate users necessary for authorization of the transaction. In some embodiments of the present invention, the subset of the set of legitimate users that must grant authorization are explicitly named. In some embodiments of the present invention, detect users mod 306 determines the subset of the set of legitimate users required based, at least in part, on the set of configured transaction rules. In some embodiments of the present invention, detect users mod 306 determines a set of proxies for the subset of the set of legitimate users. In some embodiments of the present invention, a set of proxies are stored within proxy storage 218. In some embodiments of the present invention, detect users mod 306 determines that a proxy in the set of proxies has listed a proxy (a second-order proxy). In some embodiments of the present invention, a proxy replaces a legitimate user in the set of legitimate users. In this example, detect users mod 306 determines that the two legitimate users to be contacted are the CEO and CFO of the company. Detect users mod 306 also determines that the CEO listed the COO as a proxy.

Processing proceeds to operation S270, where determine contact mod 308 determines a best contact method for the subset of the set of legitimate users. In some embodiments of the present invention, the best contact method for a legitimate user is an email address. Alternatively, the best contact method for a legitimate user is one of: (i) an SMS address; (ii) an instant message address; (iii) a telephone number; (iv) a mobile application; and/or (v) other real-time or near-instantaneous communication methods. In some embodiments of the present invention, determine contact mod 308 also determines an alternate contact method (also sometimes called a backup contact method) for the legitimate users. In some embodiments of the present invention, an alternate contact method is one of: (i) an email address; (ii) an SMS address; (iii) an instant message address; (iv) a telephone number; (v) a mobile application; and/or (vi) a real-time or near-instantaneous communication method. In some embodiments of the present invention, determine contact mod 308 also determines a best contact method for a proxy (also sometimes called a backup). In this example, the CEO has listed an instant message address as a best contact method and has listed the COO as a proxy. The COO has listed an SMS address as a best contact method. The CFO has listed an instant message address as a best contact method and has listed an email address as an alternate contact method.

Processing terminates at operation S275, where initiate authorization mod 310 initiates an authorization inquiry for the transaction authorization request. In some embodiments of the present invention, the subset of the set of legitimate users authorize the transaction. In some embodiments of the present invention, initiate authorization mod 310 transmits details of the transaction to the subset of the set of legitimate users. In some embodiments of the present invention, initiate authorization mod 310 transmits to the subset of the set of legitimate users the name of the user or legitimate user that initiated the transaction authorization request. In some embodiments of the present invention, initiate authorization mod 310 transmits an authorization inquiry to each legitimate user in the subset of the set of legitimate users. In some embodiments of the present invention, initiate authorization mod 310 transmits an authorization inquiry to each legitimate user in the subset of the set of legitimate users according to the respective best contact methods. In some embodiments of the present invention, initiate authorization mod 310 transmits the authorization inquiry to each legitimate user in the subset of the set of legitimate users according to the respective alternate contact methods. In some embodiments of the present invention, initiate authorization mod 310 transmits the authorization inquiry to each legitimate user in the subset of the set of legitimate users according to the alternate contact method in parallel with transmission of the authorization inquiry according to the best contact method.

In some embodiments of the present invention, initiate authorization mod 310 includes a time limit for a response. In some embodiments of the present invention, initiate authorization mod 310 determines a time limit for a response based on a configured transaction rule. In some embodiments of the present invention, initiate authorization mod 310 does not receive a response from a legitimate user in the set of legitimate users within a time limit. In some embodiments of the present invention, if initiate authorization mod 310 does not receive a response from a legitimate user in the set of legitimate users within a time limit, initiate authorization mod 310 transmits an authorization inquire to a proxy for the legitimate user. In some embodiments of the present invention, if the user does not respond to the authorization inquiry within a time limit, initiate authorization mod 310 determines that the transaction authorization request is not approved. In some embodiments of the present invention, once a proxy is contacted, the proxy treated as the legitimate user under the configured transaction rules. In some embodiments of the present invention, a user initiating the transaction authorization request cannot be a proxy. In some embodiments of the present invention, a legitimate user initiating the transaction authorization request cannot be a proxy. In some embodiments of the present invention, initiate authorization mod 310 does not contact a second-order proxy.

In some embodiments of the present invention, initiate authorization mod 310 transmits updates to the user and/or legitimate user who initiated the transaction authorization request. In some embodiments of the present invention, initiate authorization mod 310 transmits updates to the user and/or legitimate user with the status of the authorization inquiry. In some embodiments of the present invention, initiate authorization mod 310 determines a response to the authorization inquiry based, at least in part, on a set of one-time passwords. In some embodiments of the present invention, initiate authorization mod 310 determines a response to the authorization inquiry based, at least in part, on a legitimate user signing into a mobile application. In some embodiments of the present invention, initiate authorization mod 310 determines a response to the authorization inquiry based, at least in part, on a biometric security on a legitimate user device sub-system. In some embodiments of the present invention, initiate authorization mod 310 determines a response to the authorization inquiry based, at least in part, on an encrypted passcode.

In this example, initiate authorization mod 310 transmits an authorization inquiry to the CEO at legitimate user device sub-system 106 and to the CFO at legitimate user device sub-system 108 via the respective best contact methods (both an instant message address). Initiate authorization mod 310 also transmits an authorization inquiry to the CFO via an alternate contact method (an email address). Initiate authorization mod 310 does not receive a response from the CEO within the time limit (in this example, five seconds) and transmits an authorization inquiry to the CEO's proxy, the COO at proxy device sub-system 110 via an SMS address. Initiate authorization mod 310 receives an approval to the authorization inquiry from the COO. However, initiate authorization mod 310 receives a disapproval to the authorization inquiry from the CFO. Therefore, the transaction authorization request is not approved and the user cannot complete the transaction.

### III. FURTHER COMMENTS AND/OR EMBODIMENTS

Some embodiments of the present invention recognize the following facts, potential problems, and/or potential areas for improvement with respect to the current state of the art: (i) requirements for transaction approvals have become complex; and (ii) one-time passwords are used to verify an identity.

FIG. 4 shows flowchart 400 depicting a method according to the present invention. In this example, a teenage child initiates a transaction to purchase a video game for $50.

Processing begins at operation S405, where an authorization server sub-system receives a transaction authorization request. In some embodiments of the present invention, the authorization server sub-system determines the set of configured transaction rules, the set of legitimate users, the set of proxies, and the set of best contact methods as part of receiving the transaction authorization request. In this example, a teenage child is at a store in a mall and wants to purchase a new video game. The set of configured transaction rules include a configured transaction rule that authorization must be received from one legitimate user and a tiebreaking rule that alternates between legitimate users and uses the other legitimate user as a proxy. The set of legitimate users includes the teenage child's mother and father. The mother's best contact method is an SMS address. The father's best contact method is an instant message address.

Processing proceeds to operation S410, where the authorization server sub-system transmits an authorization inquiry to a set of legitimate users. In this example, the tiebreaking rule determines that the mother is the legitimate user to be contacted and the father is the proxy. The authorization server sub-system transmits the authorization inquiry to the mother's legitimate user device sub-system via an SMS address.

Processing proceeds to operation S415, where the authorization server sub-system receives an approval from the initiating user. In some embodiments of the present invention, authorization server sub-system assumes that the user initiating the transaction authorization request will approve the transaction. In some embodiments of the present invention, operation S415 is omitted and processing proceeds from operation S410 to operation S420. In this example, the authorization server sub-system receives an approval from the teenage child via a user device sub-system.

Processing proceeds to decision operation S420, where the authorization server sub-system decides if the set of legitimate users have timely responded to the authorization inquiry. In some embodiments of the present invention, the authorization server sub-system uses a specific time deadline. Alternatively, the authorization server sub-system determines the amount of time to wait based, at least in part, on one or more of: (i) a configured transaction rule; and/or (ii) a preset. In some embodiments of the present invention, the authorization server sub-system updates the user who initiated the transaction approval request, on a dynamic basis, with the status of the authorization inquiry for each legitimate user. In some embodiments of the present invention, the status of the authorization inquiry for each legitimate user is updated based on a set of trigger events. In some embodiments of the present invention, the set of trigger events includes a change in the status of the authorization inquiry. In some embodiments of the present invention, the authorization server sub-system receives instructions from the user who initiated the transaction authorization request to extend the allowable response time. If the authorization server sub-system receives a response in a timely manner, processing proceeds through the “Yes” path. If the authorization server sub-system does not receive a response in a timely manner, processing proceeds through the “No” path. In this example, the mother is in a business meeting and cannot timely respond to the authorization inquiry and processing proceeds through the “No” path. Had the mother been able to respond in a timely manner, processing would have proceeded through the “Yes” path.

Following the “Yes” path from operation S420, processing proceeds to operation S425, where the authorization server sub-system receives a password and a response from the legitimate user. In some embodiments of the present invention, the password is any method of uniquely identifying the user. In some embodiments of the present invention, the response from the user is a “yes” or a “no.” In this example, if the mother were not in a meeting, she could have responded with her password and responded to the authorization inquiry.

Following the “No” path from operation S420, processing proceeds to operation S430, where the authorization server sub-system transmits an authorization inquiry to the proxy for the legitimate user. In some embodiments of the present invention, processing returns to operation S410, with the proxy used in place of the legitimate user. In this example, the father is listed as the proxy for the mother and the authorization server sub-system transmits the authorization inquiry to him.

Processing proceeds to operation S435, where the authorization server sub-system receives the password and the response from the proxy. In some embodiments of the present invention, the password is any method of uniquely identifying the user. In some embodiments of the present invention, the response from the user is a “yes” or a “no.” In this example, the authorization server sub-system receives a password and a “yes” response to the authorization inquiry.

Processing terminates at operation S440, where the authorization server sub-system authenticates the password and enters the response from the legitimate user (or the proxy). In some embodiments of the present invention, authenticating involves confirming the password. In some embodiments of the present invention, authenticating involves transmitting the response to the user who initiated the transaction authorization request.

In some embodiments of the present invention, multiple individuals must authenticate and/or approve a near-instant transaction authorization request. Some embodiments of the present invention minimize transaction delay. In some embodiments of the present invention, a user is provided a dynamic status of approvals. Some embodiments of the present invention employ security protocols. In some embodiments of the present invention, a security protocol includes session management. In some embodiments of the present invention, session management includes revoking an access of a legitimate user if the legitimate user is idle. In some embodiments of the present invention, an approval process is initiated on a mobile application. In some embodiments of the present invention, a mobile application follows strict session maintenance. In some embodiments of the present invention, a mobile application invalidates a session if inactive for a period of time. In some embodiments of the present invention, a legitimate user cannot be validated if a mobile application invalidates a session. In some embodiments of the present invention, a legitimate user must reinitiate a session to restore a session. In some embodiments of the present invention, dynamic status updates forestall a period of inactivity.

In some embodiments of the present invention, a communication channel (e.g., SMS, telephone, etc.) is unavailable for a user and/or a legitimate user. In some embodiments of the present invention, multiple communication channels are unavailable for a user and/or a legitimate user. In some embodiments of the present invention, a user and/or a legitimate user is available on a subset of a set of communication channels and the user and/or legitimate user is unavailable on a second subset of the set of communication channels.

Some embodiments of the present invention detect a subset of the set of legitimate users required to authenticate and/or authorize a transaction. In some embodiments of the present invention, a subset of the set of legitimate users required to authenticate a transaction are a subset of the set of legitimate users required to authorize a transaction. In some embodiments of the present invention, determining a subset of the set of legitimate users is based, at least in part, on a set of configured transaction rules.

Some embodiments of the present invention determine a best contact method for a legitimate user. In some embodiments of the present invention, a best contact method includes a near-instantaneous communication. In some embodiments of the present invention, a legitimate user is contacted to authenticate and/or authorize a transaction. In some embodiments of the present invention, contacting a user to authenticate and/or authorize a transaction is a verification process. In some embodiments of the present invention, a legitimate user authenticates, approves, and/or authorizes a transaction. In some embodiments of the present invention, a legitimate user refuses to authenticate, rejects, and/or disapproves a transaction. In some embodiments of the present invention, a legitimate user initiates a transaction authorization request. In some embodiments of the present invention, a legitimate user initiating a transaction authorization request enters a password to approve a transaction.

Some embodiments of the present invention check a near-instant connectivity for a subset of the set of legitimate users. In some embodiments of the present invention, an authorization inquiry is not transmitted to a legitimate user lacking a near-instant connectivity. In some embodiments of the present invention, a near-instant connectivity includes, but is not limited to, protocols for: (i) SMS; (ii) email; (iii) instant messaging; and/or (iv) any other near-instant communication protocol. In some embodiments of the present invention, a subset of the set of legitimate users enter a password to approve and/or authorize a transaction.

In some embodiments of the present invention, a subset of a subset of the set of legitimate users has a unique password. In some embodiments of the present invention, every legitimate user in the subset of the set of legitimate users has a same password. In some embodiments of the present invention, a password is received over a wireless network protocol. In some embodiments of the present invention, a password is received over a wired network protocol. In some embodiments of the present invention, a password is received over an SMS network protocol. In some embodiments of the present invention, an application software is loaded onto a device to be used in implementing user verification. In some embodiments of the present invention, the application software integrates with one or more of: (i) an SMS service; (ii) an instant message service; and/or (iii) an email service. In some embodiments of the present invention, the application software manages network connectivity for a device.

In some embodiments of the present invention, the software application interacts with the user for input and output. In some embodiments of the present invention, the software application displays a dynamic status of an authorization inquiry process. In some embodiments of the present invention, a dynamic status of a transaction includes a visual display of names and indicators of a status. In some embodiments of the present invention, various operations correspond to various status indicators. In some embodiments of the present invention, a one-time password (OTP) is used to for verification. In some embodiments of the present invention, a software application determines if a device is secured by a user. In some embodiments of the present invention, a software application will not allow entry of an OTP if a device is not secured by a user. In some embodiments of the present invention, a password is encrypted before transmission. In some embodiments of the present invention, an OTP is encrypted before transmission.

In some embodiments of the present invention, a user named as a necessary approver for a transaction names a proxy if the user is unavailable. In some embodiments of the present invention, a user identifies a best contact method. In some embodiments of the present invention, a user identifies an alternate contact method. In some embodiments of the present invention, a best contact method or an alternate contact method are related to an availability of a subscriber identity module (SIM) card. In some embodiments of the present invention, contacting a proxy involves only transmitting a notice that the primary contact is being sought. In some embodiments of the present invention, a proxy cannot approve or disapprove a transaction. In some embodiments of the present invention, a legitimate user changes a proxy. In some embodiments of the present invention, a legitimate user includes multiple proxies and the proxy used for a transaction authorization request is determined based on configured transaction rules.

Some embodiments of the present invention may include one, or more, of the following features, characteristics, and/or advantages: (i) determining a set of users for an account; (ii) determining a set of users required to approve a transaction on an account; (iii) determining a set of rules for transactions on an account; (iv) determining a best contact method for each user; (v) determining an alternate contact method for each users; and/or (vi) determining a proxy for each user.

Some embodiments of the present invention may include one, or more, of the following features, characteristics, and/or advantages: (i) employing near-instantaneous communication methods; (ii) reducing transaction delay; (iii) reducing time needed to receive approvals for a transaction; (iv) employing redundancy for user contact methods; and/or (v) employing proxies for unreachable users.

Some embodiments of the present invention may include one, or more, of the following features, characteristics, and/or advantages: (i) updates transaction status in a dynamic manner to a user; (ii) monitors application session security; (iii) minimizes delays in transaction approval; (iv) authorizes or rejects transaction based on response from other users; (v) encrypts passwords for security; and/or (vi) employs means to contact users out of network connectivity range.

Some embodiments of the present invention may include one, or more, of the following features, characteristics, and/or advantages: (i) authenticating transactions for a joint user account; (ii) authenticating transactions based on the availability of users on a joint account; (iii) identifying users to authenticate a transaction based on account rules; (iv) determining a best contact method for a user; (v) determining a near-instantaneous contact method for a user; and/or (vi) notifying users of the approval status for other users.

### IV. DEFINITIONS

“Present invention” does not create an absolute indication and/or implication that the described subject matter is covered by the initial set of claims, as filed, by any as-amended set of claims drafted during prosecution, and/or by the final set of claims allowed through patent prosecution and included in the issued patent. The term “present invention” is used to assist in indicating a portion or multiple portions of the disclosure that might possibly include an advancement or multiple advancements over the state of the art. This understanding of the term “present invention” and the indications and/or implications thereof are tentative and provisional and are subject to change during the course of patent prosecution as relevant information is developed and as the claims may be amended.

“Embodiment,” see the definition for “present invention.”

“And/or” is the inclusive disjunction, also known as the logical disjunction and commonly known as the “inclusive or.” For example, the phrase “A, B, and/or C,” means that at least one of A or B or C is true; and “A, B, and/or C” is only false if each of A and B and C is false.

A “set of” items means there exists at least one item. A “subset of” items or a “subset of a set of” items means there exists at least one item within the “set of” items.

A “plurality of” items means there exists at least two items.

“Includes” and any variants (e.g., including, include, etc.) means, unless explicitly noted otherwise, “includes, but is not necessarily limited to.”

A “user” or a “subscriber” includes, but is not necessarily limited to: (i) a single individual human; (ii) an artificial intelligence entity with sufficient intelligence to act in the place of a single individual human or more than one human; (iii) a business entity for which actions are being taken by a single individual human or more than one human; and/or (iv) a combination of any one or more related “users” or “subscribers” acting as a single “user” or “subscriber.”

The terms “receive,” “provide,” “send,” “input,” “output,” and “report” should not be taken to indicate or imply, unless otherwise explicitly specified: (i) any particular degree of directness with respect to the relationship between an object and a subject; and/or (ii) a presence or absence of a set of intermediate components, intermediate actions, and/or things interposed between an object and a subject.

A “module” is any set of hardware, firmware, and/or software that operatively works to do a function, without regard to whether the module is: (i) in a single local proximity; (ii) distributed over a wide area; (iii) in a single proximity within a larger piece of software code; (iv) located within a single piece of software code; (v) located in a single storage device, memory, or medium; (vi) mechanically connected; (vii) electrically connected; and/or (viii) connected in data communication. A “sub-module” is a “module” within a “module.”

A “computer” is any device with significant data processing and/or machine readable instruction reading capabilities including, but not necessarily limited to: desktop computers; mainframe computers; laptop computers; field-programmable gate array (FPGA) based devices; smart phones; personal digital assistants (PDAs); body-mounted or inserted computers; embedded device style computers; and/or application-specific integrated circuit (ASIC) based devices.

“Electrically connected” means either indirectly electrically connected such that intervening elements are present or directly electrically connected. An “electrical connection” may include, but need not be limited to, elements such as capacitors, inductors, transformers, vacuum tubes, and the like.

“Mechanically connected” means either indirect mechanical connections made through intermediate components or direct mechanical connections. “Mechanically connected” includes rigid mechanical connections as well as mechanical connection that allows for relative motion between the mechanically connected components. “Mechanically connected” includes, but is not limited to: welded connections; solder connections; connections by fasteners (e.g., nails, bolts, screws, nuts, hook-and-loop fasteners, knots, rivets, quick-release connections, latches, and/or magnetic connections); force fit connections; friction fit connections; connections secured by engagement caused by gravitational forces; pivoting or rotatable connections; and/or slidable mechanical connections.

A “data communication” includes, but is not necessarily limited to, any sort of data communication scheme now known or to be developed in the future. “Data communications” include, but are not necessarily limited to: wireless communication; wired communication; and/or communication routes that have wireless and wired portions. A “data communication” is not necessarily limited to: (i) direct data communication; (ii) indirect data communication; and/or (iii) data communication where the format, packetization status, medium, encryption status, and/or protocol remains constant over the entire course of the data communication.

The phrase “without substantial human intervention” means a process that occurs automatically (often by operation of machine logic, such as software) with little or no human input. Some examples that involve “no substantial human intervention” include: (i) a computer is performing complex processing and a human switches the computer to an alternative power supply due to an outage of grid power so that processing continues uninterrupted; (ii) a computer is about to perform resource intensive processing and a human confirms that the resource-intensive processing should indeed be undertaken (in this case, the process of confirmation, considered in isolation, is with substantial human intervention, but the resource intensive processing does not include any substantial human intervention, notwithstanding the simple yes-no style confirmation required to be made by a human); and (iii) using machine logic, a computer has made a weighty decision (for example, a decision to ground all airplanes in anticipation of bad weather), but, before implementing the weighty decision the computer must obtain simple yes-no style confirmation from a human source.

“Automatically” means “without any human intervention.”

1. A method comprising:
determining a set of configured transaction rules for a transaction authorization request;
transmitting an authorization inquiry to a set of legitimate users over a set of best contact methods, respectively;
receiving from the set of legitimate users a set of responses to the authorization inquiry; and
determining a result of the transaction authorization request based, at least in part, on the set of responses to the authorization inquiry;
wherein:
the set of legitimate users is based, at least in part, on the set of configured transaction rules; and
at least the determining a set of configured transaction rules operation is performed by computer software running on computer hardware.

2. The method of claim 1, wherein each best contact method in the set of best contact methods is one of: a mobile application, an SMS address, or an email address.

3. The method of claim 1, wherein the set of configured transaction rules includes a configured transaction rule implementing a monetary threshold.

4. The method of claim 1, wherein receiving from the set of legitimate users a set of responses to the authorization inquiry:
identifying the set of legitimate users based, at least in part, on a password.

5. The method of claim 4, wherein a legitimate user in the set of legitimate users has a unique password.

6. The method of claim 1, further comprising:
transmitting an authorization inquiry to a proxy over a best contact method; and
receiving from the proxy a proxy response to the authorization inquiry;
wherein:
a response to the authorization inquiry is not received from a legitimate user in the set of legitimate users;
a configured transaction rule in the set of configured transaction rule indicates the proxy to replace the legitimate user; and
the result of the transaction authorization request is further based, at least in part, on the proxy response.

7. The method of claim 1, further comprising:
transmitting, in parallel with the transmitting the authorization inquiry operation, the authorization inquiry to a legitimate user in the set of legitimate users over an alternate contact method;
wherein:
the alternate contact method is one of: a mobile application, an SMS address, or an email address.

8. The method of claim 1, further comprising:
updating, based on a set of trigger events, a user with a status of the set of responses to the authorization inquiry.

9. A computer program product comprising a computer readable storage medium having stored thereon:
first instructions executable by a device to cause the device to determine a set of configured transaction rules for a transaction authorization request;
second instructions executable by a device to cause the device to transmit an authorization inquiry to a set of legitimate users over a set of best contact methods, respectively;
third instructions executable by a device to cause the device to receive from the set of legitimate users a set of responses to the authorization inquiry; and
fourth instructions executable by a device to cause the device to determine a result of the transaction authorization request based, at least in part, on the set of responses to the authorization inquiry;
wherein:
the set of legitimate users is based, at least in part, on the set of configured transaction rules.

10. The computer program product of claim 9, wherein each best contact method in the set of best contact methods is one of: a mobile application, an SMS address, or an email address.

11. The computer program product of claim 9, wherein the third instructions to receive from the set of legitimate users a set of responses to the authorization inquiry includes:
fifth instructions executable by a device to cause the device to identify the set of legitimate users based, at least in part, on a password;
wherein:
a legitimate user in the set of legitimate users has a unique password.

12. The computer program product of claim 9, further comprising:
fifth instructions executable by a device to cause the device to transmit an authorization inquiry to a proxy over a best contact method; and
sixth instructions executable by a device to cause the device to receive from the proxy a proxy response to the authorization inquiry;
wherein:
a response to the authorization inquiry is not received from a legitimate user in the set of legitimate users;
a configured transaction rule in the set of configured transaction rule indicates the proxy to replace the legitimate user; and
the result of the transaction authorization request is further based, at least in part, on the proxy response.

13. The computer program product of claim 9, further comprising:
fifth instructions executable by a device to cause the device to transmit, in parallel with the second instructions to transmit an authorization inquiry, the authorization inquiry to a legitimate user in the set of legitimate users over an alternate contact method;
wherein:
the alternate contact method is one of: a mobile application, an SMS address, or an email address.

14. The computer program product of claim 9, further comprising:
fifth instructions executable by a device to cause the device to update, based on a set of trigger events, a user with a status of the set of responses to the authorization inquiry.

15. A computer system comprising:
a processor set; and
a computer readable storage medium;
wherein:
the processor set is structured, located, connected, and/or programmed to execute instructions stored on the computer readable storage medium; and
the instructions include:
first instructions executable by a device to cause the device to determine a set of configured transaction rules for a transaction authorization request;
second instructions executable by a device to cause the device to transmit an authorization inquiry to a set of legitimate users over a set of best contact methods, respectively;
third instructions executable by a device to cause the device to receive from the set of legitimate users a set of responses to the authorization inquiry; and
fourth instructions executable by a device to cause the device to determine a result of the transaction authorization request based, at least in part, on the set of responses to the authorization inquiry;
wherein:
the set of legitimate users is based, at least in part, on the set of configured transaction rules.

16. The computer system of claim 15, wherein each best contact method in the set of best contact methods are one of: a mobile application, an SMS address, or an email address.

17. The computer system of claim 15, wherein the third instructions to receive from the set of legitimate users a set of responses to the authorization inquiry includes:
fifth instructions executable by a device to cause the device to identify the set of legitimate users based, at least in part, on a password;
wherein:
a legitimate user in the set of legitimate users has a unique password.

18. The computer system of claim 15, further comprising:
fifth instructions executable by a device to cause the device to transmit an authorization inquiry to a proxy over a best contact method; and
sixth instructions executable by a device to cause the device to receive from the proxy a proxy response to the authorization inquiry;
wherein:
a response to the authorization inquiry is not received from a legitimate user in the set of legitimate users;
a configured transaction rule in the set of configured transaction rule indicates the proxy to replace the legitimate user; and
the result of the transaction authorization request is further based, at least in part, on the proxy response.

19. The computer system of claim 15, further comprising:
fifth instructions executable by a device to cause the device to transmit, in parallel with the second instructions to transmit an authorization inquiry, the authorization inquiry to a legitimate user in the set of legitimate users over an alternate contact method;
wherein:
the alternate contact method is one of: a mobile application, an SMS address, or an email address.

20. The computer system of claim 15, further comprising:
fifth instructions executable by a device to cause the device to update, based on a set of trigger events, a user with a status of the set of responses to the authorization inquiry.
